(19) United States
(12) Patent Application Publication
(10) Pub. No.: US 2004/0118438 A1
(43) Pub. Date: Jun. 24, 2004

(54) Method for removing electrically conductive materials containing silver from electrodeposited parts

(76) Inventors: Susanne Ruebel, Karlsbad (DE); Thomas Guenthner, Calw (DE)

Correspondence Address: NATH & ASSOCIATES PLLC, Sixth Floor, 1030 15th Street, N.W., Washington, DC, 20005, US

(21) Appl. No.: 10/366,600

(22) Filed: Feb. 14, 2003

(30) Foreign Application Priority Data
Dec. 19, 2002 (EP) 02028477.4

(51) Int. Cl. B08B 7/00

(52) U.S. Cl. 134/38; 134/42; 510/385; 510/391

(57) ABSTRACT

In the case of a method for removing electrically conductive materials containing silver from electrodeposited parts, in particular, electroformed dental parts, the part is treated with iodine and/or at least one compound containing iodine under at least one processing step. The iodine/compound containing iodine is/are preferably present in the form of a solution or a dispersion in at least one polar solvent. Inorganic iodides and iodophores are prime candidates as the compound containing iodine.

The invention primarily relates to a method for removing electrically conductive materials containing silver, such as electrically conductive lacquers, from electrodeposited parts, in particular, electroformed dental parts.

One of the current standard methods for manufacturing metallic parts in general, particularly preformed parts for dental prostheses, is electrodeposition of metals. In the case of the so-called “electroforming,” precious metals, such as gold and gold alloys, are primarily employed. Moldings/preformed parts manufactured using this method, in particular, such in the form of so-called “dental supporting structures,” to which ceramics or plastics may then be applied, may be used for the known dental and dental-laboratory purposes. Electroformed parts that are used in telescopic and bridgework technology and as suprastructures and similar are also manufactured by electrochemical means.

Regardless of the particular applications of the moldings/electroformed parts involved, the surfaces to be electroplated must be coated with an electrically conductive material (conductive material), usually silver, prior to electrodeposition. Electrically conductive silver lacquers are usually used for this purpose. In addition to a lacquer constituent, the latter usually also contain silver particles. Electrically conductive silver coatings may be applied in various ways and by various means, where a brush, fiber-tipped pen (similar to a felt-tipped pen), or an airbrush method are usually used. This electrically conductive coating on dielectric substrate materials, such as plaster, plastics, or ceramics, yields an electrically conductive surface. In the case of electrically conductive substrate materials, such as metals and alloys, it serves as an electrically conductive intermediate layer that allows keeping the electrodeposited plating separated from the substrate material. In either case, most of the electrically conductive silver coating remains in place on the electrodeposited plating following separation of the electrodeposited plating from the substrate material.

Removing all of this electrically conductive silver coating from electrodeposited parts/electroformed parts is essential to the utilization and functionalities of electroformed parts manufactured in this manner, particularly in the case of dental parts.

Electroposited platings are subject to special requirements that, particularly in the case of dental parts, may also vary, depending upon the particular type of dental support or electroformed part manufactured. Prerequisites for being able to subsequently apply a ceramic or plastic facing to electroformed parts are, e.g., a homogeneous plating structure, a highly uniform plating thickness, and a reproducible composition of the deposited plating. This is particularly true for ceramic facings, where the electroformed part involved must be fired at high temperatures, in some cases, several times, following application of the ceramic compound. The metallic supporting structure must also be have the necessary ability to withstand firing. In all cases, minimal requirements imposed on other properties, such as wear resistance, porosity, and corrosion resistance, will also have to be met. Regarding the further utilization and functionalities of electrodeposited preformed parts, it should be particularly emphasized that their electrodeposited platings must be free of contaminants of any kind. Various types of processing problems, including even total failure of electroformed parts to comply with their functionalities as supporting structures for dental prostheses, may arise, depending upon the particular types and quantities of contaminants present. For example, contaminants, such as grease or oils, on those surfaces (outer surfaces) of electroformed parts to be faced with ceramics may cause bubbles to form in the ceramic layer, and contaminants that adversely affect the adhesive joint between the electrodeposited metallic plating and layer of facing may cause the layer of facing to peel off, either at isolated locations or over large areas. If some or all of the electrically conductive silver coating remains on the electrodeposited metallic plating, bubbles in the layer of facing, even deformations of the electrodeposited metallic plating, may occur.

Furthermore, a reproducibly high purity of the materials employed is essential to the appearances and biocompatibilities of the materials involved, particularly in the case of dental parts. For example, gold or gold-alloy platings with ultrahigh purities are required in the case of patients suffering from allergies. In that conjunction, silver from electrically conductive silver coatings that have been either incompletely removed or not been removed at all represents both a potential allergy risk and causes dark discolorations of the gingiva (gums) near the edges of crowns.

The commercial methods and equipment used for electroforming dental parts thus usually use nitric acid to remove electrically conductive silver coatings from electrodeposited metallic platings. In some cases, sandblasting may also be used to remove the electrically conductive silver coating, provided that no particular requirements regarding, e.g., a smooth finish and smooth gliding over the outer surface of a metallic or ceramic primary crown, are imposed on the inner surface of the electroformed part, in particular, that of a crown.

Since silver, as a precious metal, is not attacked by aqueous solutions of hydrochloric acid or other nonoxidizing acids, it may be dissolved by oxidizing acids (nitric acid or hot, concentrated, sulfuric acid) and alkaline cyanide solutions (source: Römpp Lexikon, Chemical Version 2.0, Georg Thieme Verlag, Stuttgart/New York (1999)). Special requirements apply to methods to be used for removing silver-lacquer coatings from electroformed parts to be used as supporting structures for dental parts. For example, the method cannot have any adverse effects on the electroformed parts themselves. Several methods for chemically/electrochemically dissolving silver familiar to specialists in the field are thus inapplicable here, since they may also attack and damage their electrodeposited metallic plating on a massive scale. The methods available for removing the mostly electrodeposited gold and gold-alloy platings are thus particularly severely restricted. Such methods must also be simply utilizable, and utilizable without risks of any major safety hazards arising, by users, such as dental technicians and dentists and their personnel, with little specialized knowledge of chemical-laboratory practices.

Both methods (chemical etching/leaching and sandblasting) have some serious disadvantages. Nitric acid strongly attacks the skin, eyes, and mucous membranes and causes wounds that are slow to heal. Inhalation of its vapors and the usual dissolved nitrous gases may cause lung inflammations and etching of the pulmonary alveoli. If nitric acid, which will usually be in the form of a 25-%-35-% solution, is used, the best effectiveness and perfectly reliable removal of the silver lacquer will be obtained only if the electroformed parts involved are boiled in the acid. Since this method necessitates employment of an acid-resistant exhaust hood, it may be used in a few cases only. Placing the nitric acid and electroformed part in a hermetically sealed, plastic vessel and cleaning the part in an ultrasonic-cleaning bath, rather than boiling it in the nitric acid, will significantly extend the time required to remove the electrically conductive silver coating from the part and mean that the certainty that even the minutest silver residues will be removed will no longer apply. Furthermore, in some countries, such as the USA, the purchase and shipment of nitric acid for use by untrained personnel is prohibited by stringent shipping and handling guidelines.

Using sandblasting to remove the electrically conducting silver coating also involved hazards and will not always be possible. Using a jet pressure that is too high or the wrong grain size or wrong abrasive material may cause deformations of the electroformed metallic part. If the abrasive jet is incorrectly used, the silver might, in some cases, be driven into the metallic plating rather than removed.

The invention thus addresses, among other things, the problem of providing a method for removing electrically conductive materials containing silver from electroformed parts for use on dental prostheses that will avoid at least some of the aforementioned disadvantages. In particular, removal of electrically conductive silver should be made more reliable and the handling of the method used for that purpose further simplified. Users should also have the opportunity to avail themselves of a method that involves only minor safety hazards. Finally, the solutions that the method uses should largely consist of physiologically harmless compounds in order that they will not be subject to any special shipping restrictions or require any special handling.

The invention solves that problem by means of a method having those characteristics stated in claim 1. Preferred embodiments of that method are stated in the dependent claims, claims 2-15. The invention also encompasses the use of iodine or a compound containing iodine claimed in claim 16 and the use of the solutions or dispersions defined under claims 17-23. The wording appearing in all claims is herewith made a part of the contents of this description by way of reference thereto.

The method mentioned at the outset hereof, is, in accordance with the invention, characterized by the fact that the part/preformed part is treated with iodine and/or at least one compound containing iodine during at least one partial step of the method, where the part involved may, in general, consist of any arbitrary (electrodepositable) material, preferably a metallic material. Noteworthy in that conjunction are the cases discussed at the outset hereof, where the part/preformed part involved consists of at least one precious metal or at least one precious-metal alloy. In particular, the method according to the invention finds application in the case of parts/preformed parts, onto which gold or gold alloys have been electrodeposited.

In the case of the method according to the invention, the iodine and/or compound containing iodine will be present in the form of a solution or dispersion thereof containing at least one solvent, where the term “dispersion” shall be construed as referring to the general sense of the term, and shall encompass suspensions, emulsions, colloidal solutions, and similar, depending upon the particular agent used. In particular, these solutions or dispersions may contain suitable additives known from the state of the art that will stabilize these solutions/dispersions or improve their physical and chemical properties, depending upon the particular agent (iodine/compound containing iodine) used. The additives involved here might be, for example, glycerin, citric acid, sodium hydroxide, potassium hydroxide, or other choices of additive.

Solvents according to the invention might be any solvent known to specialists in the field that are suitable for dissolving iodine or the compounds containing iodine to be involved. Included thereunder are water, as well as organic solvents or admixtures thereof with water. The organic solvents involved include solvents, such as carbon disulfide, benzene, chloroform, tetrachloromethane, and similar that contain no oxygen, as well as organic solvents, such as ether, acetone, and alcohols, that contain oxygen. In the case of the alcohols, the alkanols are particularly good choices, where ethanol is particularly worthy of note.

Pure iodine and its properties are sufficiently well-known that preparation of suitable solutions/dispersions thereof presents no problems to specialists in the field. Coming into question as compounds containing iodine are, in general, any and all inorganic or organic iodine compounds known to specialists in the field.

Iodides are the preferred choice here, where “iodides” shall be construed as referring to any and all known inorganic or organic iodide compounds where iodine occurs as their electronegative constituent. Among those iodides, inorganic iodides are, in accordance with the invention, the preferred choice, where the salts sodium iodide and potassium iodide are particularly good candidates. In addition to iodides, iodates, iodoxides, and other organic iodine compounds are also worthy of note.

Other compounds containing iodine that are preferentially utilizable in the method according to the invention are the so-called “iodophores.” As is well-known, included under “iodophores” are surfactants containing iodine consisting of (poly)carbonic acids, tensides, or polymers, preferably polyvinylpyrrolidone (PVP), which contains from 0.5% to several percent iodine in the form of a chemically bound “active-iodine complex.” In view of the comparatively strong bonding of their iodine, these iodophores have only slight iodine odors and low corrosivities and toxicities. Iodophores have been used in disinfectants and antiseptics for years.

Preferred iodophores that may be used in methods according to the invention may be collectively referred to using the term “polyvidone-iodine.” “Polyvidone” is the name assigned to polyvinylpyrrolidones having various chain lengths that, in the case of polyvidone-iodine, are incorporated into an iodine complex. Their iodine contents range up to 12% freely available iodine. Alcohols and/or water are the solvents primarily used. The molecular weight of the polyvinylpyrrolidones used is relatively unimportant, and may vary over the range typical of commercially available products, which extends from 2,500 g/mole to 750,000 g/mole. However, low-molecular-weight, precipitable, polyvinylpyrrolidones having molecular weights ranging from 2,500 g/mole to 25,000 g/mole are preferably used.

In the case of preferred embodiments of the method according to the invention, the electrodeposited part/electroformed part is treated with a solution that contains iodine and at least one compound containing iodine. This solution thus contains both dissolved iodine and at least one soluble iodine compound. The iodine compound(s) involved may be either an iodide or iodides, preferably an inorganic iodide or iodides, and/or an (inorganic) iodate or iodates. Here, once again, sodium iodide and, in particular, potassium iodide, are the preferred iodine compounds worthy of mention. However, in the case of such embodiments, use of a solution containing polyvidone-iodine as their iodine compound is to be preferred.

In the case of highly preferred embodiments of the method according to the invention, the electrodeposited part/electroformed part is treated with a solution that contains water, ethanol, iodine, and potassium iodide. Electrically conductive materials that contain silver may be particularly readily removed from electrodeposited parts, particularly parts fabricated from gold or gold alloys, using such solutions. Such solutions may also be particularly simply prepared in the form of clear solutions having reddish-brown colorations.

In the case of highly preferred embodiments of the method according to the invention, the solutions/dispersions used are largely free of any physiologically harmful basic constituents or additives. This is particularly true in the case of those embodiments wherein solutions of iodine and/or an inorganic iodide, in particular, potassium iodide, in water and/or alcohol are used.

Also particularly worthy of note are embodiments wherein iodine and potassium iodide are present in the form of aqueous or alcoholic solutions thereof. The invention allows using such solutions in various concentrations (molarities). Iodine-potassium-iodide solutions hydrolyze iodine to potassium tri-iodide, where polyiodide ions (I₃⁻ to I₉⁻, in particular, I₅⁻, I₇⁻, and I₉⁻) are formed at high iodine concentrations, which results in much more iodine being dissolved than would otherwise correspond to its nominal solubility. The iodine in these polyiodides is so weakly bound that it will be readily liberated by any type of chemical reaction. In practice, such iodine-potassium-iodide solutions thus behave in the same manner as true (highly) concentrated iodine solutions.

In the case of the invention, it will also be preferable if the dispersion used, or, in particular, the solution used, contains the iodine compound in a concentration ranging from 0.05 mg/l to the saturation concentration. In particular, concentrations ranging from 100 g/l to 1.44 kg/l are preferred, where, within that range, concentrations ranging from 500 g/l to 1 kg/l are much to be preferred. The (additional) concentrations of iodine contained in dispersions, or preferably, in solutions, are also relatively unimportant. Particularly worthy of note in this conjunction are iodine concentrations ranging from 0.05 mg/l to the saturation concentrations (of iodine in iodine-potassium-iodide solutions). The iodine concentration may, preferably, range from 0.5 g/l to 20 g/l, in particular, from 10 g/l to 20 g/l.

The durations of the treatments of electrodeposited parts/electroformed parts with iodine and/or an iodine compound or compounds may, in general, be arbitrarily chosen, in particular, they may be chosen to suit the part/electroformed part to be treated and the agent(s) used. It may prove beneficial, in that conjunction, to conduct the treatments involved at temperatures above room temperature, e.g., at temperatures up to 50° C. As an alternative thereto, or in addition thereto, treatment may be enhanced using ultrasound in, for example, an ultrasonic cleaning bath. Typical treatment durations range from around 1 min to several hours, where treatment durations ranging from around 1 min to around 1 h are particularly worthy of note. The benefits of the invention are frequently achieved for treatment durations ranging from around 1 min to around 10 min. Treatment durations of, e.g., 3 min or less, in an iodine-potassium-iodide solution containing around 2 g iodine and around 90 g potassium iodide in 100 ml water in an ultrasonic cleaning bath will thus be sufficient to remove all electrically conductive silver applied prior to electrodeposition of a gold layer. However, if merely the ultrasonic bath is dispensed with under the same conditions, the treatment duration required will be extended to no more than around 6 min to 8 min.

In the case of other preferred embodiments of the method according to the invention, areas of the electrodeposited part/electroformed part that exhibit no electrically conductive material containing silver are protected prior to treatment with iodine and/or at least one iodine compound. This measure is intended to prevent unnecessary attack of the associated areas of the part/preformed part that, under some circumstances, cannot be precluded. That protection of such areas preferably involves applying a protective coating, in particular, a layer of a protective lacquer, to those areas. The lacquers involved may be such known under the terms “peel-off lacquers,” “foil lacquers,” and similar, where commercially available, self-hardening, silicone-based, protective films, such as that supplied by the firm of Erkodent (Deutschland) under the tradename “Erkosin,” are the preferred choice. Such protective films may be simply and readily peeled off without leaving any residues behind once the method has been concluded.

In the case of the invention, it will be preferable if the treatment with iodine and/or at last one iodine compound is the sole processing step used for removing electrically conductive materials containing silver. However, this method according to the invention may be combined with other processing steps, such that the treatment with iodine/iodine compound(s) represents merely one partial step of the full treatment, where, in particular, the aforementioned treatment with oxidizing acids and sandblasting could be the additional processing steps involved and the ordering of the individual processing steps will be relatively unimportant.

Electroformed parts are separated from substrate materials using techniques known to specialists in the field, whereby the electrodeposited metallic plating remains in place on one side, hereinafter also referred to as the “inner surface,” of the parts, that bearing the adhesive, electrically conductive, silver lacquer. Once the final processing step for removing the electrically conductive material containing silver has been concluded, in particular, following conclusion of the treatment with iodine and/or at least one iodine compound according to the invention, the electrodeposited part/electroformed part may be subjected to a suitable post-treatment. The parts/preformed parts are, for example, rinsed in a solvent, preferably water, in particular, running water, following their removal from the treatment solution for this purpose. To the extent that areas of the parts/preformed parts have been coated with a protective coating or protective lacquer, the latter is then removed and the parts/preformed parts subsequently rerinsed in a solvent, preferably water. The parts/preformed parts may then be thoroughly cleaned inside and out using a steam jet, a processing step commonly used in dental laboratories for removing any residual adhering contaminants. The parts/preformed parts are then blow-dried, in particular, using compressed air. In the event that any localized yellowish-white deposits should appear, these will be silver-iodide deposits loosely adhering to the part/preformed part that may be readily removed by recleaning the areas involved with a steam jet. Of course, parts/preformed parts that have been rinsed in a solvent, in particular, water, may also be initially blow-dried using compressed air, in which case, some of the silver-iodide deposits that may have formed will peel off, in which case, only any residues of such deposits that may remain in place will need to be subsequently removed using a steam jet.

As stated above, in addition to the method according to the invention, the invention also comprises use of iodine, or a compound containing iodine, for removing electrically conductive materials containing silver, such as silver lacquers, from electrodeposited parts, in particular, from electroformed dental parts. According to the invention, the iodine or compound containing iodine is being made available for the associated purpose for the first time. Regarding the implementation of this application in accordance to the invention, we explicitly cite the description of the method according to the invention and herewith make explicit reference thereto.

Finally, the invention comprises a solution or dispersion that contains iodine and/or at least one compound containing iodine in at least one polar solvent. Regarding the composition and properties of such solutions, we explicitly cite the wording of claims 18-23 and herewith make explicit reference thereto, and to the description of the method according to the invention, which also discloses characteristics of the claimed solution/dispersion. A solution according to the invention that contains iodine, potassium iodide, and/or polyvidone-iodine in water and/or ethanol shall be here explicitly emphasized.

In the case of the invention, it has, surprisingly, been found that, in the case of the preferred, electrodeposited, gold and gold-alloy dental platings, silver coatings may be removed using the method according to the invention without adversely impacting any of the requirements imposed on such platings. Attacks on these metallic platings were to be expected under some circumstances, particularly in the case of gold and gold-alloy platings, due to their close chemical and physical relationships to silver. Since the silver coatings involved are manually applied and thus have variable thicknesses, it might be feared that, in contrast to the case of areas that have thicker silver coatings, at least those areas that are more rapidly freed of silver, even those on the outer surfaces of the electrodeposited metallic platings that have exposed, will have already been attacked from below. It was thus all that more surprising that slightly reddish discolorations due to loosely adhering deposits of colloidal gold occurred only in exceptional cases, and even then, only at certain locations, even in the case of gold and gold-alloy platings that had not been exposed. In the event that these deposits are regarded as disturbing, if at all, they may be subsequently readily removed using, for example, a nonabrasive camel's-hair brush.

The other benefits of the invention described herein are that the solutions employed are not classified as hazardous substances and no special regulations thus apply to their purchase and shipment. Introducing such a method into foreign countries should thus also present no problems. Moreover, a major benefit is that the method may be conducted by persons lacking specialized knowledge of chemical-laboratory practices and many of the processing steps involved are already well-known from daily routine work in the dental-laboratory field. Also worthy of emphasis are the method's short processing times and greatly reduced safety hazards compared to cases where the nitric-acid treatments that have thus far been used must be handled. The method according to the invention also provides cost benefits, since the solutions involved may be reused several times, where the number of times involved will depend upon their compositions, which will reduce operating costs. For example, a solution having the aforementioned composition may be used to reliably free as many as 40 electroformed parts from, electrically conductive silver, which would not be the case if 100 ml of dilute nitric acid were used.

In concluding, we once again point out that the major demands imposed on the method, namely, that it leave electrodeposited parts/electroformed parts undamaged in view of the need for biocompatibility, an attractive appearance, and functionality will be fully met, and the method thus provides simple, rapid, and safe means for removing electrically conductive silver, in particular, removing electrically conductive silver from electroformed parts for use on dental prostheses.

The foregoing and other features of the invention ensue from the following examples in conjunction with the subordinate claims, where the individual features involved may be implemented either alone or in the form of combinations thereof.

### EXAMPLES

### Example 1

Solution 1:

100 g water

20 g PVP (molecular weight=10,000)

2.2 g iodine

1 g glycerin

1 g citric acid

0.54 g KOH

0.5 g Na₂HPO₄

An electroformed (99.99-% purity) gold part coated with a layer of electrically conductive silver lacquer is treated in the above solution in an ultrasonic cleaning bath for 30 minutes. It is then thoroughly rinsed in water, steam-cleaned with a steam jet, and blown dry with compressed air. No yellowish-white deposits occur subsequent to the blow-drying with compressed air. The silver has been totally removed. On closer examination, the surface of the gold is found to exhibit only a few, isolated, reddish spots. The part's functionality has not been adversely affected.

### Example 2

Solution 2:

100 g water

20 g PVP-iodine complex

An electroformed (99.9-% purity) gold part coated with a layer of electrically conductive silver lacquer is treated in the above solution in an ultrasonic cleaning bath for 60 minutes. It is then thoroughly rinsed in water and blown dry with compressed air. Yellowish-white deposits occur subsequent to the blow-drying with compressed air. These are removed using a steam jet. The electroformed part is subsequently blown dry with compressed air once again. The silver has now been totally removed. On closer examination, the surface of the gold is found to exhibit only a few, small, isolated, reddish spots. The part's functionality has not been adversely affected.

### Example 3

Solution 3:

2.5 tsp. Iodine

2.5 tsp. potassium iodide

28.5 tsp. water

66.5 tsp. ethanol

An electroformed (99.7-% purity) gold part coated with a layer of electrically conductive silver lacquer is treated in the above solution in an ultrasonic cleaning bath for 10 minutes, then thoroughly rinsed in water, steam-cleaned with a steam jet, and blown dry with compressed air. No yellowish-white deposits occur subsequent to the blow-drying with compressed air. The silver has been totally removed. Most of the surface of the gold exhibits a reddish-brown coloration. The part's functionality has not been adversely affected.

### Example 4

Solution 3 from Example 3:

The outer surface of an electroformed (99.7-% purity) gold part coated with a layer of electrically conductive silver lacquer is coated with a silicone-based cover-lacquer and subsequently treated in the above solution in an ultrasonic cleaning bath for 10 minutes. It is then thoroughly rinsed in water and the layer of cover-lacquer peeled off. It is then rinsed in water once again and steam-cleaned with a steam jet, and blown dry with compressed air. No yellowish-white deposits occur subsequent to the blow-drying with compressed air. The silver has been totally removed. The surface of the gold is still shiny and gold-colored following removal of the electrically conductive silver lacquer. The part's functionality has not been adversely affected.

### Example 5

Solution 5:

100 g water

91 g potassium iodide

1.9 g iodine

The outer surface of an electroformed (99.99-% purity) gold part coated with a layer of electrically conductive silver lacquer is covered with wax. The part is then treated in the above solution for 6 minutes. It is then thoroughly rinsed in water and its wax coating removed. It is subsequently rinsed in water once again, steam-cleaned with a steam jet, and blown dry with compressed air. No yellowish-white deposits occur subsequent to the blow-drying with compressed air. The silver has been totally removed. The surface of the gold is still shiny and gold-colored following removal of the electrically conductive silver lacquer. The part's functionality has not been adversely affected.

### Example 6

Solution 5 from Example 5:

Eight electroformed parts coated with a layer of electrically conductive silver lacquer are treated in the same solution used in Example 5 in an ultrasonic cleaning bath for 4 minutes. They are then thoroughly rinsed in water, steam-cleaned with a steam jet, and blown dry with compressed air. No yellowish-white deposits occur subsequent to the blow-drying with compressed air. The silver has been totally removed. The surface of the gold is reddish-brown in spots. The part's functionality has not been adversely affected.

### Example 7

Solution 7:

100 g water

45 g potassium iodide

0.2 g iodine

Five electroformed (99.9-%-purity) gold parts coated with a layer of electrically conductive silver lacquer are treated in the solution in an ultrasonic cleaning bath for 5 minutes. They are then thoroughly rinsed in water, steam-cleaned with a steam jet, and blown dry with compressed air. No yellowish-white deposits occur subsequent to the blow-drying with compressed air. The silver has been totally removed. The surface of the gold is reddish-brown in spots. The part's functionality has not been adversely affected.

1. A method for removing electrically conductive materials containing silver, such as electrically conductive lacquers, from electrodeposited parts, wherein the part is treated with at least one compound from the group consisting of iodine and compounds containing iodine under at least one constituent step of the method.

2. The method according to claim 1, wherein said at least one compound is present in the form of a solution or a dispersion in at least one solvent.

3. The method according to claim 2, wherein said solvent is a polar solvent.

4. The method according to claim 3, wherein said solvent is water or an alcohol.

5. The method according to claim 4, wherein said solvent is ethanol.

6. The method according to claim 1, wherein said compound containing iodine is an inorganic iodide.

7. The method according to claim 6, wherein said inorganic iodide is sodium iodide, or potassium iodide.

8. The method according to claim 1, wherein said compound containing iodine is an iodophore.

9. The method according to claim 8, wherein said iodophore is polyvidone-iodine.

10. The method according to claim 1, wherein the electrodeposited part is treated with a solution containing iodine and at least one compound containing iodine.

11. The method according to claim 10, wherein said compound containing iodine is an inorganic iodide.

12. The method according to claim 10, wherein said compound containing iodine is polyvidone-iodine.

13. The method according to claim 1, wherein the electrodeposited part is treated with a solution of iodine and potassium iodide in water and ethanol.

14. The method according to claim 1, wherein the iodine content in a solution or dispersion ranges from 0.05 mg/l to the saturation concentration.

15. The method according to claim 1, wherein the content of the compound containing iodine in a solution or dispersion ranges from 0.05 mg/l to the saturation concentration.

16. The method according to claim 1, wherein the treatment duration ranges from 1 min to several hours.

17. The method according to claim 1, wherein the areas of the electrodeposited part that exhibit no electrically conductive material containing silver are protected prior to treatment by applying a protective coating.

18. A solution or dispersion of at least one compound from the group consisting of iodine and compounds containing iodine in at least one polar solvent.

19. The solution or dispersion according to claim 18, wherein said compound containing iodine is an inorganic iodide.

20. The solution or dispersion according to claim 18, wherein said compound containing iodine is an iodophore.

21. The solution or dispersion according to claim 18, wherein the solvent is water or an alcohol.

22. The solution according to claim 18, having the following constituents:
iodine,
at least one compound from the group consisting of potassium iodide and polyvidone-iodine, and
at least one solvent from the group consisting of water and ethanol.

23. The solution according to claim 22, wherein the iodine content ranges from 0.5 g/l to 20 g/l.

24. The solution according to claim 22, wherein the content of said compound ranges from 10² g/l to 1.44×10³ g/l.
